(19) United States
(12) Patent Application Publication
(10) Pub. No.: US 2016/0357948 A1
(43) Pub. Date: Dec. 8, 2016

(54) INFORMATION PROCESSING DEVICE AND MANAGEMENT METHOD

(71) Applicant: FUJITSU LIMITED, Kawasaki-shi (JP)

(72) Inventor: Yoshiteru Takeuchi, Yokohama (JP)

(73) Assignee: FUJITSU LIMITED, Kawasaki-shi (JP)

(21) Appl. No.: 15/096,359

(22) Filed: Apr. 12, 2016

(30) Foreign Application Priority Data
Jun. 4, 2015 (JP) 2015-114002

(51) Int. Cl. G06F 21/10; H04L 29/08; G06Q 50/00

(52) U.S. Cl. CPC G06F 21/105; G06Q 50/00; H04L 67/025; G06Q 2220/18; G06F 2221/0773

(57) ABSTRACT

A method includes changing, by a first device included in a plurality of devices, a mode of the first device to a mode in which management of the license is to be performed, collecting, by the first device, execution information indicative of whether the software is being executed by each of the plurality of devices, inquiring, by a second device included in the plurality of devices other than the first device, the first device about whether execution of the software is to be permitted, deciding, by the first device in the mode in which management of the license is to be performed, in response to the inquiry from the second device, whether the execution of the software by the second device is to be permitted based on license information indicative of a number of devices that can execute the software simultaneously and the execution information, and outputting a decision result.

### CROSS-REFERENCE TO RELATED APPLICATION

This application is based upon and claims the benefit of priority of the prior Japanese Patent Application No. 2015-114002, filed on Jun. 4, 2015, the entire contents of which are incorporated herein by reference.

### FIELD

The technology disclosed in the present embodiment relates to a technology for managing a license.

### BACKGROUND

In a computer system that includes a plurality of information processing devices, each information processing device is permitted to execute software within a range of a license provided in advance to the computer system. As one of licenses of software, a license called floating license is available. In the floating license, the number of information processing devices that are permitted to execute the software simultaneously is limited.

Where the number of information processing devices by which software is executed simultaneously is managed on the basis of a floating license, an information processing device by which the software is to be used confirms upon activation of the software whether the use by the information processing device remains within the condition of the contracted number of information processing devices by the license. For the confirmation of the simultaneously used number of the license, for example, a license management server is installed. In this case, the information processing device that receives an activation instruction of the software confirms from the license management server before starting of use of the software whether or not execution of the software is to be permitted.

As a license management technology, for example, a licensed number management device has been proposed which makes it possible to execute a given program flexibly among devices within a range of a fixed licensed number. Also another technology has been proposed which makes it possible, even in a case in which some failure or the like occurs with a certain information processing device, for a device that is to operate as an alternative to rapidly and simply utilize data, an application and information such as license information. A related technology is disclosed, for example, in Japanese Laid-open Patent Publication No. 2009-301188 or Japanese Laid-open Patent Publication No. 2009-278243.

### SUMMARY

According to an aspect of the invention, a management method for managing a license of software capable of being executed individually by a plurality of information processing devices, the management method includes changing, by a first information processing device included in the plurality of information processing devices, a mode of the first information processing device to a mode in which management of the license is to be performed, collecting, by the first information processing device, execution information indicative of whether or not the software is being executed by each of the plurality of information processing devices, inquiring, by a second information processing device included in the plurality of information processing devices other than the first information processing device, the first information processing device about whether or not execution of the software is to be permitted, deciding, by the first information processing device in the mode in which management of the license is to be performed, in response to the inquiry from the second information processing device, whether or not the execution of the software by the second information processing device is to be permitted on the basis of license information indicative of a number of information processing devices that can execute the software simultaneously and the execution information, and outputting a decision result to the second information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of license management by a system according to a first embodiment;

FIG. 2 is a view depicting an example of a system configuration of a second embodiment;

FIG. 3 is a view depicting an example of a hardware configuration of an information processing device;

FIG. 4 is a block diagram depicting functions of an information processing device;

FIG. 5 is a view depicting an example of an issuance situation of a license key;

FIG. 6 is a view depicting an example of a registration situation of a license key;

FIG. 7 is a view illustrating an example of license management by an information processing device that has a management role;

FIG. 8 is a flow chart illustrating an example of a procedure of a license key inputting process;

FIG. 9 is a flow chart illustrating an example of a process upon activation of software;

FIG. 10 is a sequence diagram illustrating an example of information updating in response to activation of software;

FIG. 11 is a flow chart illustrating an example of a procedure of a process upon stopping of software;

FIG. 12 is a flow chart illustrating an example of a procedure in regard to a first case of management role transfer;

FIG. 13 is a view illustrating an example of information updating in response to stopping of software; and

FIG. 14 is a flow chart illustrating an example of a procedure regarding a second case of management role transfer.

### DESCRIPTION OF EMBODIMENTS

Although the floating license is convenient in that software is installed in a number of information processing devices greater than a licensed number in advance and can be utilized suitably, additionally providing a license management server may be involved. The license management server is applied only in order to manage allocation of the license to information processing devices so as to limit the number of information processing devices that execute the software simultaneously to a number within the contracted licensed number. However, the license management server is not used for execution itself of the software of the license target. Therefore, the license management server does not contribute to improvement of the convenience in use of the software. In other words, if the floating license can be managed without using the license management server, then the system scale can be reduced without deteriorating the convenience in utilization of software.

According to one aspect, the present technology implements license management by a simple configuration. [0011] In the following, embodiments are described with reference to the drawings. It is to be noted that the embodiments can be carried out in a suitable combination within a range within which no inconsistency is caused.

### First Embodiment

First, a first embodiment is described. The first embodiment makes it possible to manage a floating license without using a license management server.

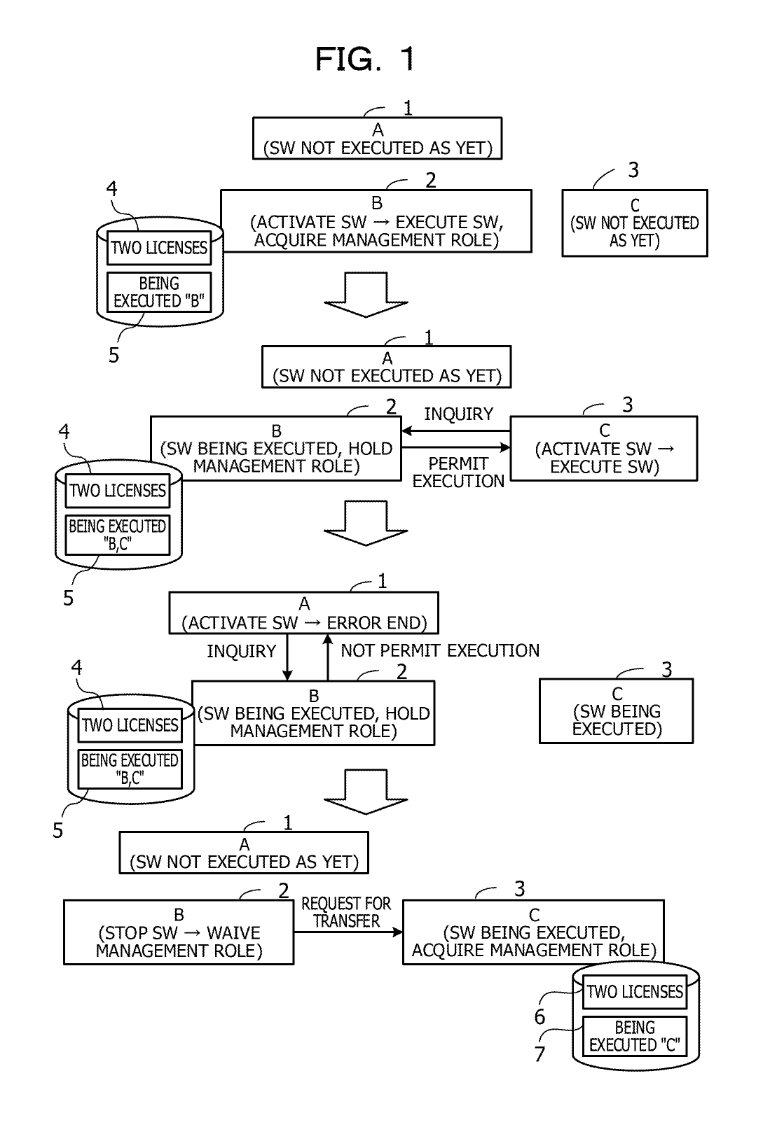

FIG. 1 is a view depicting an example of license management by a system according to the first embodiment. A plurality of information processing devices 1 to 3 are coupled to each other by a network. The information processing devices 1 to 3 are, for example, computers.

A license has been issued for software that can be executed individually by the information processing devices 1 to 3. The software of a license target is installed in advance in the information processing devices 1 to 3. It is to be noted that, where the term “software” or “pieces of software” is used in the following description, unless otherwise specified, it designates the software of the license target.

The substance of the license is stored as license information 4 or 6 in one or more information processing devices. The license information 4 or 6 indicates a number of information processing devices (licensed number) by which the software can be executed simultaneously. In the example of FIG. 1, a license that permits two information processing devices to execute the software simultaneously is issued.

One of the information processing devices 1 to 3 acquires a management role indicative of the authority to manage the license. The information processing device that has acquired the management role enters a mode in which it performs management of the license. For example, each information processing device acquires the management role if, when it starts execution of the software of the license target or while it is executing the software, none of the information processing devices 1 to 3 is in a mode in which management of the license is performed, and then performs mode transition of entering the mode in which it performs license management. In the example of FIG. 1, the software is activated by the information processing device 2, and when the information processing device 2 is to start execution of the software, it acquires the management role and performs the mode transition.

The information processing device 2 entering the mode in which license management is to be performed collects execution information 5 indicative of whether or not the software is being executed by each of the information processing devices 1 to 3. For example, the pieces of software executed by the information processing devices are coupled by peer to peer (P2P) communication. The information processing device 2 entering the mode in which license management is to be executed acquires information of the other information processing devices that are executing the software, for example, by P2P communication between the pieces of software. Accordingly, the information processing device 2 can collect the execution information 5. Also it is possible for the information processing devices that are executing the software to share the execution information 5 using an information sharing function of P2P communication. In the example of FIG. 1, at a point of time at which the information processing device 2 acquires the management role, only the information processing device 2 is executing the software of the license target.

Thereafter, when an information processing device other than the information processing device 2 from among the information processing devices 1 to 3 tries to activate, for example, the software, the information processing device contacts the information processing device 2 to inquire about whether or not execution of the software is to be permitted. In the example of FIG. 1, the information processing device 3 inquires about whether or not execution of the software is to be permitted.

In the mode in which the license management is performed, the information processing device 2 receives the inquiry from the information processing device 3 about whether or not execution of the software is to be permitted and decides on the basis of the license information 4 and the execution information 5 whether or not execution of the software by the information processing device 3 of the source of the inquiry is to be permitted. For example, if the number of information processing devices that are indicated as executing the software by the execution information 5 is smaller than the licensed number indicated by the license information 4, then the information processing device 2 decides that the execution is to be permitted. In the example of FIG. 1, at a point of time of the inquiry from the information processing device 3, since the licensed number is “2” and the number of information processing devices that are executing the software is “1,” the execution is permitted.

If the information processing device 2 decides that the execution is to be permitted, then it notifies the information processing device 3 of the inquiry source that the execution is permitted. The information processing device 3 receiving the notification of the permission of the execution executes the software. Further, the information processing device 2 sets it to the execution information 5 that the information processing device 3 is executing the software.

While the software is being executed by the information processing devices 2 and 3, the information processing device 1 may try to execute the software. In this case, the information processing device 1 issues an inquiry to the information processing device 2 about whether or not execution of the software is to be permitted. At the point of time of the inquiry from the information processing device 1, the licensed number is “2” and the number of information processing devices by which the software is being executed is “2.” Therefore, the information processing device 2 does not permit the execution. When the information processing device 2 does not permit the execution, it transmits a notification that the execution is not permitted to the information processing device 1 from which the inquiry has been received. Consequently, the information processing device 1 fails to activate the software and ends by error.

Thereafter, when the information processing device 2 having the management role is to stop the software, it cancels the mode in which management of the license is performed and waives the management role. Then, the information processing device 2 transmits a transfer request of the management role to the information processing device 3 by which the software is being executed. The information processing device 3 receives the transfer request and acquires the management role. Then, the information processing device 3 collects latest execution information 7 and starts license management using the license information 6 held in advance and the execution information 7.

In this manner, in the first embodiment, one of the plurality of information processing devices 1 to 3 that can execute the software has a management role and performs license management of the software. Therefore, there is no necessity to additionally provide a license management server. As a result, the scale of the entire system can be reduced.

Further, since collection of execution information is performed by P2P communication, also there is no necessity to prepare a server for data collection. As a result, such a situation that the scale of the system is increased in order to implement many-to-many communication between information processing devices can be avoided.

Further, since any of the information processing devices 1 to 3 acquires the management role when none of the information processing devices 1 to 3 has the management role, a plurality of information processing devices can be avoided from acquiring the management role. If a plurality of information processing devices have the management role, then license management is performed by the plural information processing devices. If this occurs, then each of the plural information processing devices that perform license management may issue an execution permission of the software simultaneously to the individual information processing devices, resulting in the possibility that the software is simultaneously executed generally by a number of information processing devices exceeding the licensed number. By limiting the number of information processing devices that have the management role to one, it is possible to avoid such a situation that the license is violated.

Further, since any of the information processing devices 1 to 3 acquires the management role when it starts execution of the software or during execution of the software, an information processing device that is not executing the software does not have the management role. Consequently, when there exists no information processing device that executes the software, also an information processing device that executes license management does not exist, and useless occurrence of a license management process is avoided.

Further, when the information processing device having the management role tries to stop execution of the software, it waives the management role, and if there exists some other information processing device that is executing the software, then the management role can be transferred to the information processing device. Consequently, such a situation that, although there exists an information processing device that is executing the software, there exists no information processing device that has the management role can be avoided.

It is to be noted that those information processing devices that are executing the software of the license management target can normally share execution information indicative of whether or not the software is being executed through P2P communication. If the execution information is shared, then even if the information processing device having the management role is stopped by a failure or the like and a normal transfer request of the management role is not issued, a different information processing device can take over the management role.

Further, any of the information processing devices 1 to 3 can acquire the license information 4 or 6 from a license key of the software inputted thereto in advance. Thereupon, it is possible to place identification information of an arbitrary communication device (representative device) on a local area network (LAN) common to the information processing devices 1 to 3 in a license key. In this case, when any one of the information processing devices 1 to 3 acquires the management role, it acquires the identification information of the representative device from the license key of the software. Then, each of the information processing devices 1 to 3 can decide whether or not it can establish coupling to the representative device that has the identification information, and when it can establish coupling to the representative device, it decides that the management role is acquired successfully and changes the mode thereof into a mode in which management of the license is to be performed. By using it as the acquisition condition of the management role that coupling to the representative device can be established in this manner, illegal use of the license key issued to a particular LAN in a different LAN can be avoided.

### Second Embodiment

Now, a second embodiment is described. In the second embodiment, license management through P2P communication and license key issuance using unique information of communication devices in a network are performed.

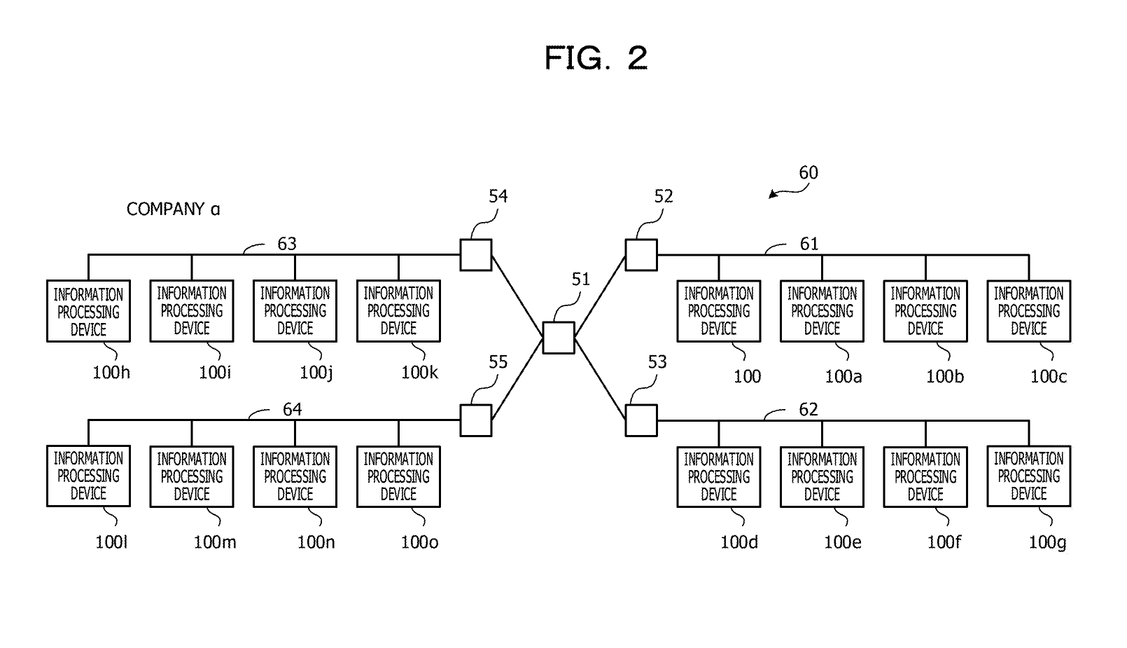

FIG. 2 is a view depicting an example of a system configuration of the second embodiment. To a LAN 60 in a company a, a plurality of information processing devices 100 and 100a to 100c, 100d to 100g, 100h to 100k and 100l to 100o are coupled with a plurality of segments 61 to 64, respectively. The segments 61 to 64 are coupled to one another by a plurality of routers 51 to 55. The information processing devices 100 and 100a to 100o are, for example, computers. The information processing devices 100 and 100a to 100o are coupled to each other by P2P communication.

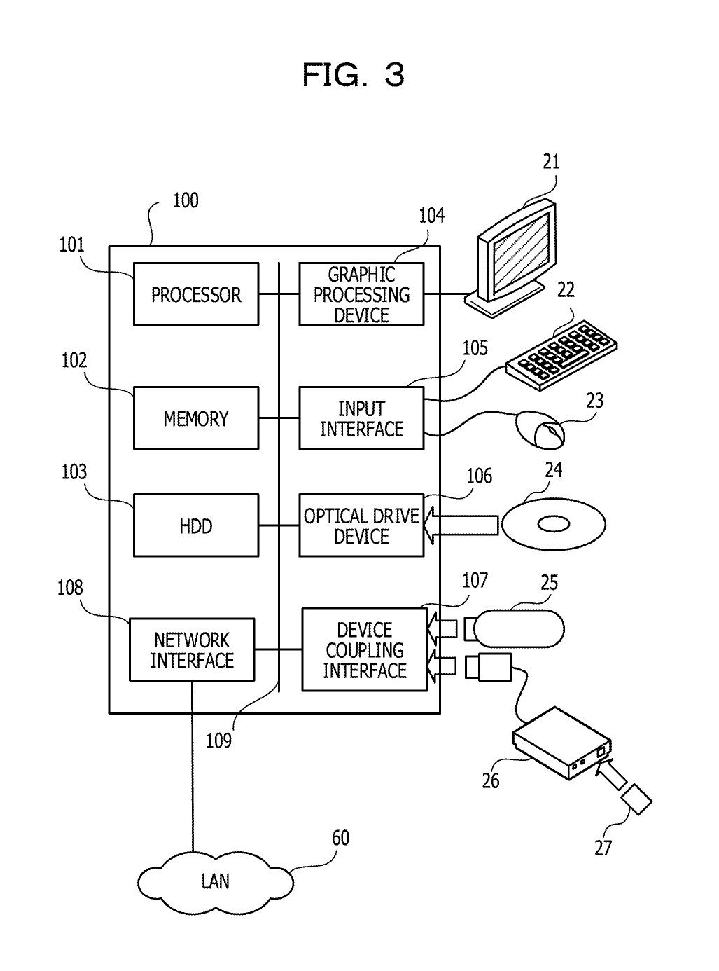

FIG. 3 is a view depicting an example of a hardware configuration of each information processing device and particularly depicts an example of a hardware configuration of the information processing device 100 as a representative of the information processing devices 100 to 100a to 100o. Referring to FIG. 3, the information processing device 100 is controlled entirely by a processor 101. A memory 102 and a plurality of peripheral apparatuses are coupled to the processor 101 through a bus 109. The processor 101 may be a multiprocessor. The processor 101 is, for example, a central processing unit (CPU), a micro processing unit (MPU) or a digital signal processor (DSP). At least part of functions executed by the processor 101 when the processor 101 executes a program may be implemented from such an electronic circuit as an application specific integrated circuit (ASIC) or a programmable logic device (PLD).

The memory 102 is used as a main storage device of the information processing device 100. Into the memory 102, at least part of a program of an operating system (OS) or an application program to be executed by the processor 101 is temporarily stored. Further, into the memory 102, various data to be used in processing by the processor 101 are stored. As the memory 102, a volatile storage device such as, for example, a random access memory (RAM) is used.

As the peripheral apparatus coupled to the bus 109, a hard disk drive (HDD) 103, a graphic processing device 104, an input interface 105, an optical drive device 106, a device coupling interface 107 and a network interface 108 are provided.

The HDD 103 magnetically performs writing and reading out of data into and from a disk built therein. The HDD 103 is used as an auxiliary storage device of the information processing device 100. In the HDD 103, a program of the OS, an application program and various data are stored. It is to be noted that, as the auxiliary storage device, also it is possible to use a nonvolatile semiconductor storage device (solid state drive: SSD) such as a flash memory.

A monitor 21 is coupled to the graphic processing device 104. The graphic processing device 104 causes the monitor 21 to display an image on a screen thereof in accordance with an instruction from the processor 101. As the monitor 21, a display device for which a cathode ray tube (CRT) is used, a liquid crystal display device and so forth are available.

A keyboard 22 and a mouse 23 are coupled to the input interface 105. The input interface 105 transmits a signal sent thereto from the keyboard 22 or the mouse 23 to the processor 101. It is to be noted that the mouse 23 is an example of a pointing device, but a different pointing device may be used. As the different pointing device, a touch panel, a tablet, a touch pad, a track ball and so forth are available.

The optical drive device 106 performs reading of data recorded on an optical disk 24 using a laser beam or the like. The optical disk 24 is a portable recording medium on which data are recorded such that they can be read by reflection of light. As the optical disk 24, a digital versatile disc (DVD), a DVD-RAM, a compact disc read only memory (CD-ROM), a CD-recordable (R)/rewritable (RW) and so forth are available.

The device coupling interface 107 is a communication interface for coupling a peripheral apparatus to the information processing device 100. For example, a memory device 25 or a memory reader/writer 26 can be coupled to the device coupling interface 107. The memory device 25 is a recording medium having a communication function with the device coupling interface 107 incorporated therein. The memory reader/writer 26 is a device that performs writing of data into a memory card 27 or reading out of data from the memory card 27. The memory card 27 is a recording medium of the card type.

The network interface 108 is coupled to the LAN 60. The network interface 108 performs transmission and reception of data to and from a different computer or a different communication device through the LAN 60.

Processing functions of the second embodiment can be implemented by such a hardware configuration as described above. Also the other information processing devices 100a to 100o can be implemented by hardware similar to that of the information processing device 100 described hereinabove with reference to FIG. 3. It is to be noted that also the apparatus described hereinabove in connection with the first embodiment can be implemented by hardware similar to that of the information processing device 100 described hereinabove with reference to FIG. 3.

The information processing device 100 implements processing functions of the second embodiment by executing a program recorded, for example, on a computer-readable recording medium. The program that describes processing contents to be executed by the information processing device 100 can be recorded in various recording media. For example, the program to be executed by the information processing device 100 can be stored in the HDD 103. The processor 101 loads at least part of the program in the HDD 103 into the memory 102 and executes the program. Also it is possible to record in advance the program to be executed by the information processing device 100 in a portable recording medium such as the optical disk 24, memory device 25 or memory card 27. The program stored in the portable recording medium is installed into the HDD 103 and enabled for execution, for example, under the control of the processor 101. Also it is possible for the processor 101 to read out the program directly from the portable recording medium and execute the program.

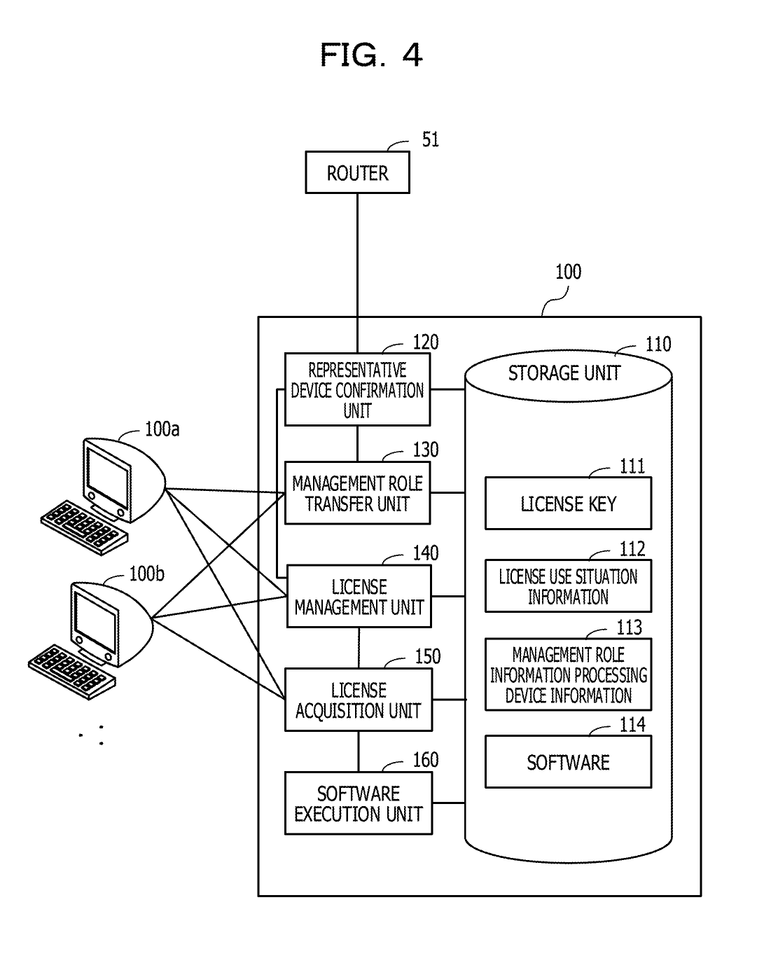

FIG. 4 is a block diagram depicting functions of each information processing device. Incidentally, the information processing device depicted in FIG. 4 may be the information processing device 100 depicted in FIG. 3. The information processing device 100 includes a storage unit 110, a representative device confirmation unit 120, a management role transfer unit 130, a license management unit 140, a license acquisition unit 150 and a software execution unit 160.

The storage unit 110 stores therein a license key 111, license use situation information 112, management role information processing device information 113 and software 114 (for example, application software). The license key 111 is a code indicating that the user in question is a legal user of the software 114. The license use situation information 112 is information relating to an information processing device that applies the license to execute the software 114. The management role information processing device information 113 is information indicative of an information processing device that has the management role. The software 114 is software that is a target of the license.

The representative device confirmation unit 120 confirms that a representative device exists in the LAN 60. The representative device is a device that represents the LAN 60 in the company α to which an execution license of the software 114 is given. For example, the router 51 in the LAN 60 serves as a representative device. The license key 111 is generated using the identification information of the representative device. For example, where the license key 111 is in a coded or encrypted form, if the license key 111 is decoded or decrypted, then the decoded code includes the identification information of the representative device. The identification information of the representative device is, for example, a media access control (MAC) address or an internet protocol (IP) address. The representative device confirmation unit 120 confirms that, when the information processing device 100 tries to acquire the management role, a representative device including the identification information extracted from the license key 111 exists in the LAN 60.

The management role transfer unit 130 performs transfer of the management role between different information processing devices. When the software is executed first in the system, the management role transfer unit 130 provides the management role to the information processing device 100 itself. Further, the management role transfer unit 130 acquires, on the basis of a request for the management role from a different information processing device, the management role from the information processing device. Further, when the information processing device 100 has the management role, if execution of the software 114 comes to an end, then the management role transfer unit 130 requests the management role to a different information processing device.

When the information processing device 100 has the management role, the license management unit 140 performs license management of the software 114. For example, the license management unit 140 decides whether or not, if it causes, in response to a license acquisition request from a different information processing device, the information processing device to execute the software 114, the number of information processing devices simultaneously executing the software exceeds the number of information processing devices permitted by the license. If the number of information processing devices permitted by the license is not exceeded, then the license management unit 140 performs allocation of the license to the information processing device from which the license acquisition request has been issued and issues a response of a message to the information processing device that the information processing device is permitted to activate the software.

It is to be noted that, if a license acquisition request is received simultaneously from a plurality of information processing devices, then the license management unit 140 queues the license acquisition requests to perform sequential processing. Consequently, such a situation that a use permission of the software is given to a number of information processing devices equal to or greater than the licensed number in error can be suppressed.

Further, the license management unit 140 performs also registration management of a license key. For example, if a license key of software is inputted by a user operation, then the license management unit 140 stores the license key into the storage unit 110. It is to be noted that, if a license key is inputted, then the license management unit 140 confirms through the representative device confirmation unit 120 that a representative device indicated by identification information included in the license key exists. Then, only when the representative device exits, the license management unit 140 stores the license key into the storage unit 110.

The license acquisition unit 150 acquires, when the software 114 is activated in the information processing device 100, the license from the information processing device that has the management role. For example, the license acquisition unit 150 transmits a license acquisition request to the information processing device that has the management role. If a response that the activation is permitted is received from the information processing device, then the license acquisition unit 150 permits the software execution unit 160 to execute the software 114.

If a permission is given from the license acquisition unit 150, then the software execution unit 160 executes the software 114.

It is to be noted that lines coupling the components depicted in FIG. 4 to each other depict part of communication paths, and also communication paths other than the depicted communication paths can be set. Further, functions of the components depicted in FIG. 4 can be implemented by causing program modules corresponding to the components to be executed by a computer.

Also the information processing devices 100a to 100o other than the information processing device 100 include functions similar to those of the information processing device 100. As a result, transfer of the management role is performed between the information processing devices 100 and 100a to 100o in equal relations. Then, license management is performed by an information processing device that has the management role. It is to be noted that it is proved, for example, by the license key 111 that the company α has a license to execute the software 114. The license key is issued by the sales source of the software.

The license key includes identification information of devices in the company α such that use of the software 114 by any other than the company α from which use of the software 114 is permitted is not permitted. Here, it may seem recommendable, for example, to create a license key including identification information of all of the information processing devices 100 and 100a to 100o in the LAN 60 of the company α for the purpose of countermeasure for illegal use of license key. However, in this case, increased labor is demanded for inputting the identification information to the information processing devices upon issuance of the license key. Besides, where a license key is issued using the identification information of all information processing devices 100 and 100a to 100o by which the software 114 is to be used, a license key is re-issued every time an information processing device is exchanged, resulting in increase in operation cost. Further, if a license key is created using identification information of all information processing devices 100 and 100a to 100o, then the size of the license key becomes excessively great, and also the labor for an inputting work of the license key into the information processing devices increases.

Therefore, in the second embodiment, only identification information of a representative device is included in a license key such that, when an information processing device is to confirm whether or not it has the license, the information processing device accesses the representative device to decide the legality of the license key.

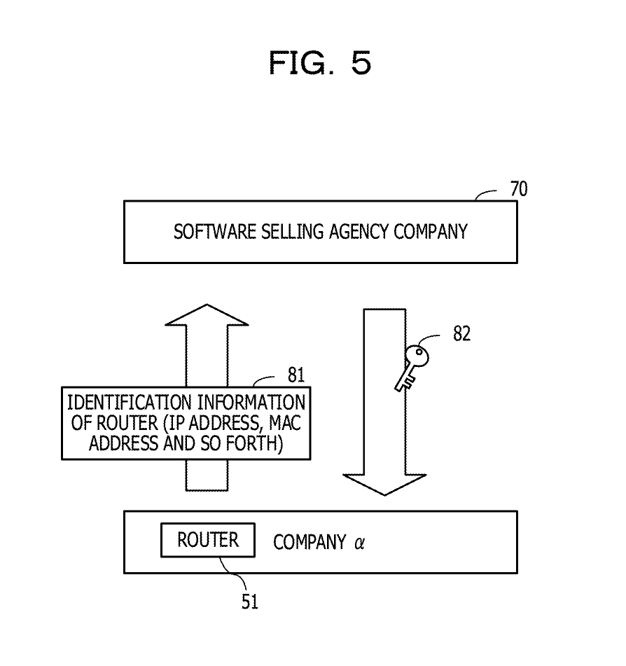

FIG. 5 is a view depicting an example of an issuance situation of a license key. For example, the company α transmits identification information 81 of the router 51 to a software selling agency company 70. The software selling agency company 70 generates a license key 82 using the identification information 81 of the router 51. For example, the software selling agency company 70 encodes a character string including the identification information 81 of the router 51 using a given algorithm to form a license key 82. The character string to be encoded can include, for example, a number of information processing devices for simultaneous execution permitted by the license. The software selling agency company 70 transmits the generated license key 82 to the company α.

The company α records the license key 82 into the information processing devices. For example, when the license key is set to one information processing device, the license key may be distributed from the information processing device to the other information processing devices.

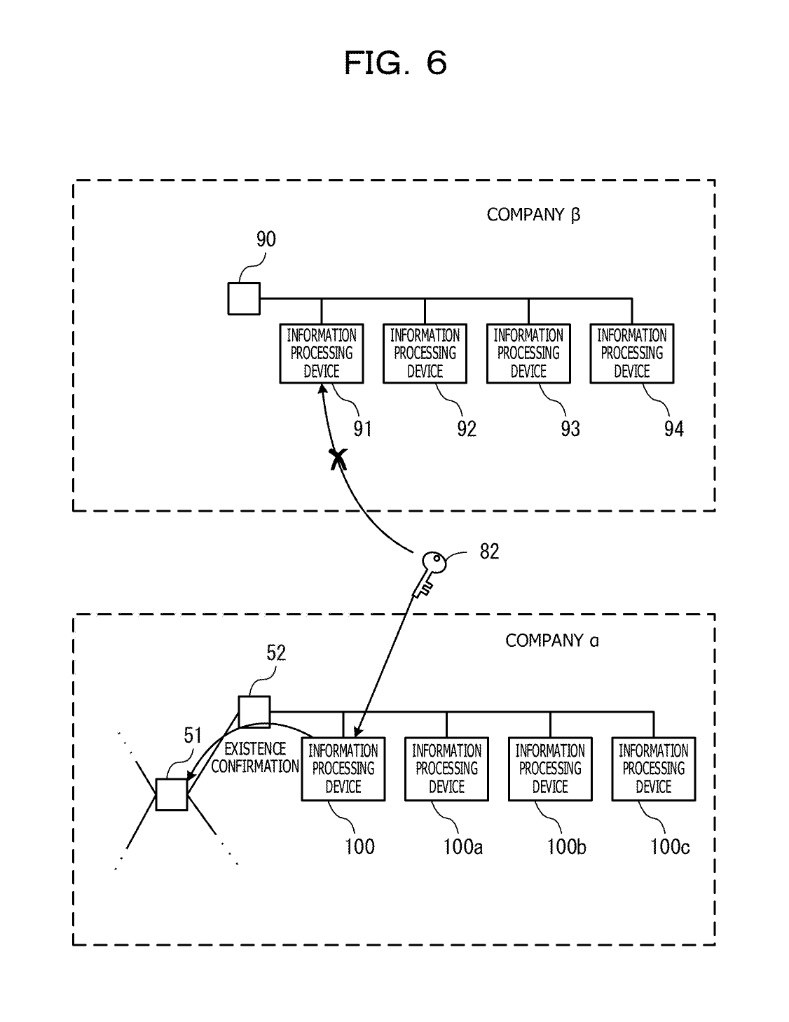

FIG. 6 is a view depicting an example of a registration situation of a license key. Incidentally, the license key depicted in FIG. 6 may be the license key 82 depicted in FIG. 5. The license key 82 is registered into the information processing device 100, for example, when the software is installed into the information processing device 100. Where the license key 82 is a character code, for example, a user who uses the information processing device 100 would input the license key 82 to the information processing device 100 using an inputting apparatus.

After the license key 82 is inputted to the information processing device 100, the information processing device 100 decodes the license key 82 that is in an encoded form and extracts an IP address or a MAC address of the router 51. Then, the information processing device 100 accesses the router 51 using the extracted IP address to acquire the MAC address from the router 51. If the information processing device 100 successfully accesses the router 51 and the MAC address of the router 51 coincides with the MAC address extracted from the license key 82, then the information processing device 100 decides that the license key 82 is legal. If the license key 82 is legal, then the information processing device 100 is permitted to use the software.

It is to be noted that use of the license key 82 by any other than the LAN 60 in the company α is not permitted. For example, another company β includes a LAN that includes a router 90 and a plurality of information processing devices 91 to 94. Here, it is assumed that it is tried to register the license key 82 into the information processing device 91 in the LAN of the company β.

The information processing device 91 accepting an input of the license key 82 extracts an IP address and a MAC address from the license key 82. Then, the information processing device 91 accesses a device corresponding to the extracted IP address to acquire a MAC address. At this time, if the device corresponding to the extracted IP address does not exist in the LAN of the company β, then the access is decided as an error and it is decided that the license key 82 is illegal. If a device corresponding to the extracted IP address exists in the LAN of the company β, then the MAC address acquired from the device and the MAC address extracted from the license key 82 are compared with each other. Since the MAC address included in the license key 82 is that of the router 51 included in the LAN 60 of the company α, it does not coincide with the MAC address extracted from the device in the company 3. Therefore, since the MAC addresses do not coincide with each other, it is decided in the information processing device 91 that the license key 82 is illegal.

By generating a license key 82 using identification information of the router 51 (IP address or MAC address) and making it possible to decide the legality of the license key 82 through comparison of the identification information in this manner, illegal use of the license key 82 is avoided.

Besides, since identification information of the only one router 51 is used for generation of the license key 82, the labor for issuance of the license key 82 may be small. In particular, if the license key 82 can be issued only on the basis of identification information of a single apparatus (for example, the router 51), then unless the apparatus is exchanged, use of the license key 82 can be continued. Besides, the size of the license key 82 may be small. As a result, management of the license key 82 is facilitated and the operation cost can be reduced.

It is to be noted that, in the second embodiment, if the license key 82 is registered into one information processing device in the LAN 60, then the license key 82 is distributed to the other information processing devices coupled to the information processing device by P2P communication. Consequently, the labor for registration of the license key 82 is simplified. Further, when any information processing device tries to acquire the management role, it confirms that it can be coupled to the router 51 serving as a representative device. Consequently, acquisition of the management role by an information processing device decoupled from the LAN 60 of the company α can be avoided.

In the LAN 60 of the company α, one of the plurality of information processing devices 100 and 100a to 100o has the management role. Then, the information processing device that has the management role manages allocation of the license to the other information processing devices such that the number of information processing devices that are using the software simultaneously is within the number permitted by the license.

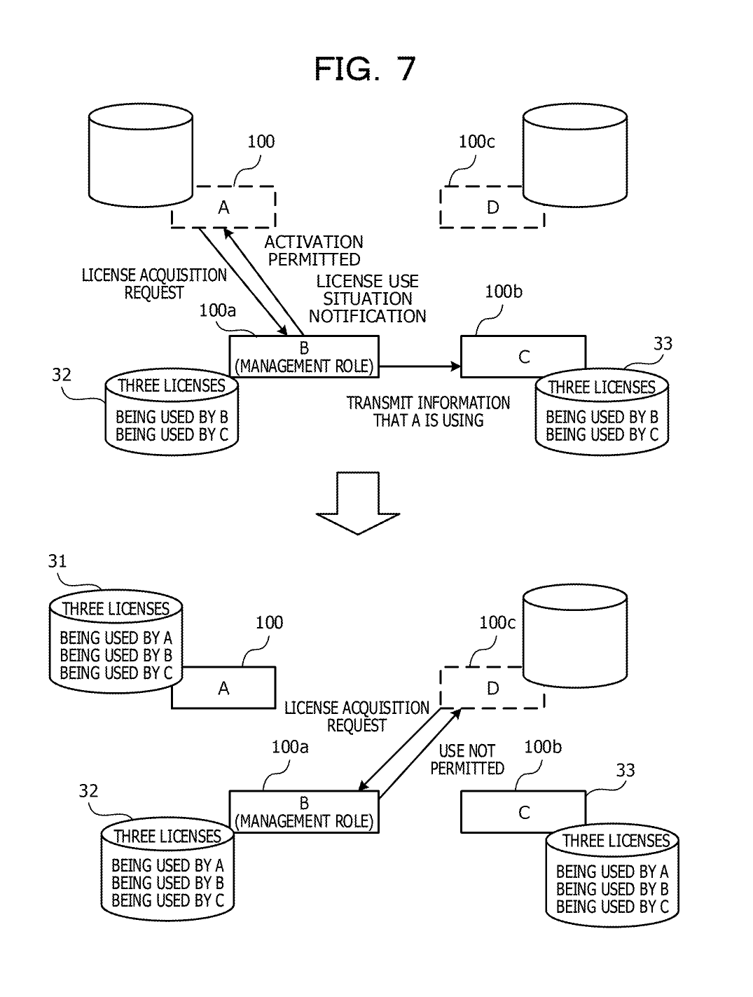

FIG. 7 is a view illustrating an example of license management by an information processing device that has a management role. In the example of FIG. 7, the information processing device 100a has the management role from among the information processing devices 100 and 100a to 100c. Further, it is assumed that the information processing devices 100a and 100b are using the software. It is to be noted that presumably the node name of the information processing device 100 is “A”; that of the information processing device 100a “B”; that of the information processing device 100b “C”; and that of the information processing device 100c “D.” At this time, in license use situation information 32 and 33 of the information processing devices 100a and 100b, it is indicated that the information processing devices having the node names “B” and “C” are using the application. Further, it is assumed that the simultaneous execution information processing device number permitted by the license is “3.”

If, in such a situation as described above, the information processing device 100 of the node name “A” tries to use the software, then a license acquisition request is transmitted from the information processing device 100 to the information processing device 100a that has the management role. The information processing device 100a performs allocation of the license to the information processing device 100 within the range of the simultaneous execution information processing device number permitted by the license in response to the license acquisition request. In the example of FIG. 7, even if the information processing device 100 starts use of the software, the number of information processing device by which the software is executed simultaneously is equal to or smaller than the number permitted by the license. Therefore, the license is allocated to the information processing device 100, and a notification that activation of the software is permitted (activation permission notification) is transmitted from the information processing device 100a to the information processing device 100.

After the information processing device 100a permits the information processing device 100 to use the software, the contents of the license use situation information 32 are updated. The information processing device 100a notifies the information processing device 100 of the license use situation information 32 after updated. The information processing device 100 newly stores license use situation information 31 in accordance with the contents of the notification.

Further, the information processing device 100a notifies the information processing device 100b, by which the software is used already, that the information processing device 100 of the node name “A” starts use of the software. The information processing device 100b updates the license use situation information 33 owned thereby in response to the notification from the information processing device 100a.

In this manner, the license use situation information 31, 32 and 33 is updated to the common contents in the information processing devices 100, 100a and 100b by which the software is being used. In the license use situation information 31, 32 and 33 after updated, it is indicated that the information processing devices 100, 100a and 100b of the node names “A,” “B” and “C” are using the application.

Thereafter, if the information processing device 100c intends to use the software, then a license acquisition request is transmitted from the information processing device 100c to the information processing device 100a that has the management role. At this time, if the information processing device 100c is permitted to use the software, then the simultaneous use information processing device number exceeds the number permitted by the license. Therefore, the information processing device 100a returns a response that the use is not permitted to the license acquisition request from the information processing device 100c.

Since the information processing device 100a having the management role performs license management in this manner, the license can be allocated appropriately to an information processing device that does not have the management role. The management role can be transferred between different information processing devices. For example, if the information processing device 100a tries to stop use of the software, then the management role is transferred from the information processing device 100a to a different information processing device. Since the information processing devices include the license use situation information of the same contents, also when the information processing device that has the management role is changed, the information processing device that newly has the management role can take over the license management immediately. Further, even if the information processing device that has the management role stops due to a failure or the like, a different information processing device can acquire the management role and take over the license management.

It is to be noted that synchronization of the license use situation information among the information processing devices illustrated in FIG. 7 can be implemented by the information sharing function, for example, of P2P communication.

In the following, processes in license management by the information processing devices are described in detail. First, a process upon inputting of a license key is described.

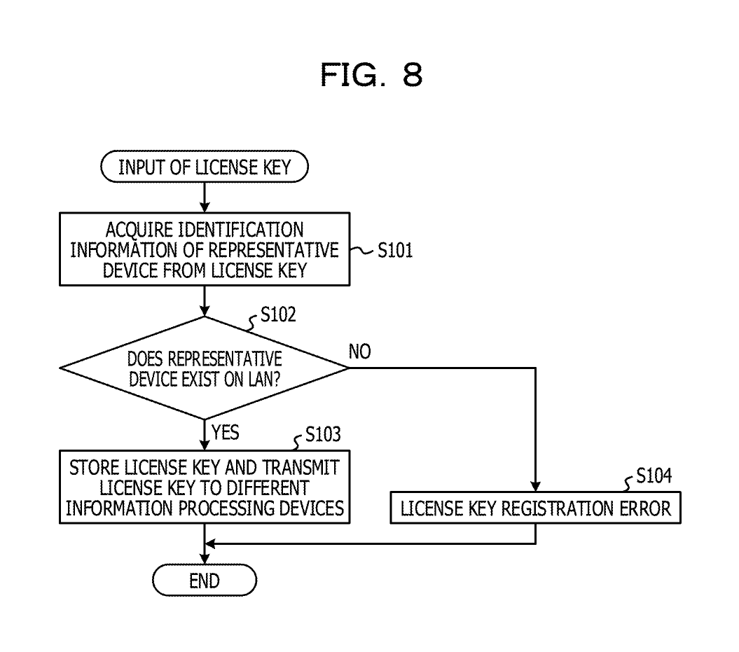

FIG. 8 is a flow chart illustrating an example of a procedure of a license key inputting process. In the following, the process illustrated in FIG. 8 is described assuming a case in which a license key is inputted to the information processing device 100. It is to be noted that the license key inputting process is executed, for example, when software is installed into the information processing device 100.

[Step S101] The license management unit 140 accepts an input of a license key and acquires identification information of a representative device from the inputted license key. For example, the license management unit 140 decodes the license key in an encoded form by a given algorithm. Then, the license management unit 140 extracts identification information of the representative device from a character string obtained by the decoding.

[Step S102] The representative device confirmation unit 120 decides whether or not the representative device exists on the LAN 60. For example, the representative device confirmation unit 120 acquires identification information of a representative device from the license management unit 140. If the identification information includes a set of an IP address and a MAC address, then the representative device confirmation unit 120 accesses the representative device in accordance with the acquired IP address to acquire a MAC address from the representative device. The representative device confirmation unit 120 can acquire a MAC address from the representative device, and if the acquired MAC address and the MAC address extracted from the license key are identical, then the representative device confirmation unit 120 decides that the representative device exists on the LAN 60. If the representative device exists on the LAN 60, then the processing advances to step S103. If the representative device does not exist on the LAN 60, then the processing advances to step S104.

[Step S103] The license management unit 140 receives, from the representative device confirmation unit 120, a notification that the representative device exists, and stores the license key 111 into the storage unit 110. Further, the license management unit 140 transmits the inputted license key to the other information processing devices coupled thereto by P2P communication. The other information processing devices store the received license key into a memory or the like of them. Thereafter, the license key inputting process is ended.

[Step S104] The license management unit 140 receives, from the representative device confirmation unit 120, a notification that the representative device does not exist, and displays a license key registration error on the monitor 21. Thereafter, the license key inputting process is ended.

The license key is registered into the information processing devices in this manner. Then, one of the plurality of information processing devices has the management role and performs license management. Any other information processing device receives, upon activation of the software therein, allocation of the license from the information processing device that has the management role.

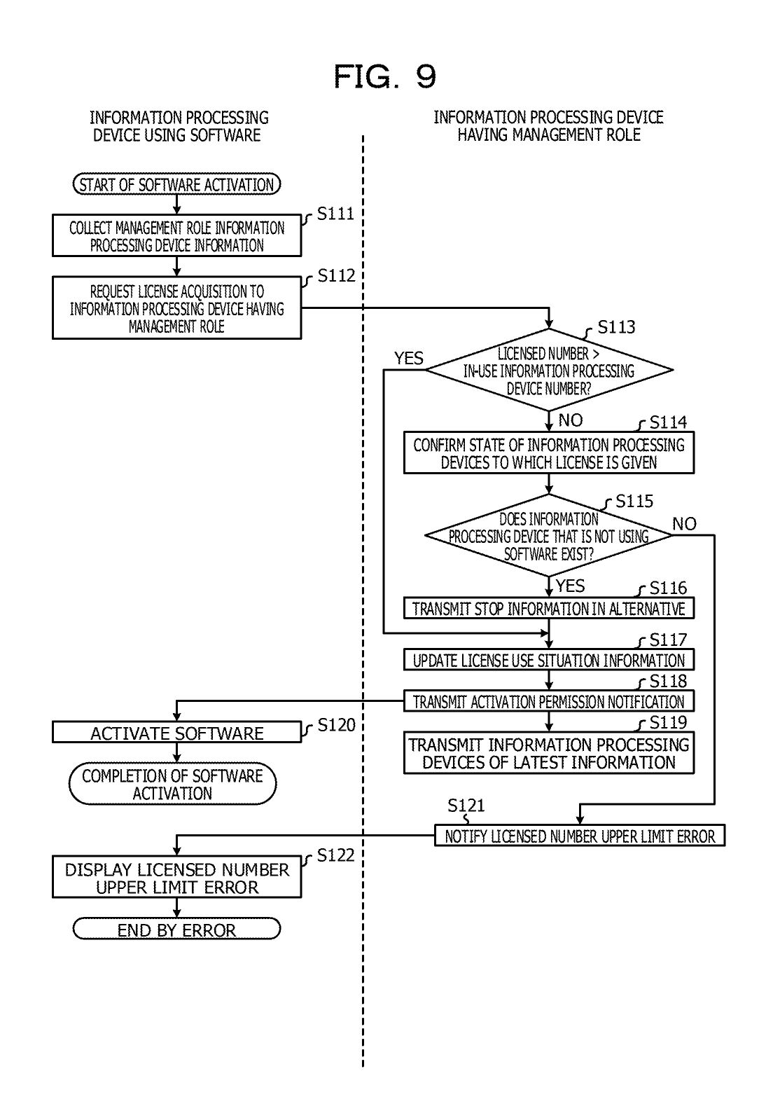

FIG. 9 is a flow chart illustrating an example of a process upon activation of software. In the following, the process of FIG. 9 is described assuming a case in which the information processing device 100 is activated when the information processing device 100a has the management role.

[Step S111] If an activation request for software is inputted, then the information processing device 100 collects management role information processing device information from the other information processing devices. For example, the information processing device 100 is coupled to the other information processing devices 100a to 100o by P2P coupling. Therefore, the information processing device 100 transmits an acquisition request for management role information processing device information to all of the other information processing devices 100a to 100o. Consequently, from those information processing devices by which the software is used, management role information processing device information is transmitted to the information processing device 100. In the example of FIG. 9, it is assumed that the acquired management role information processing device information indicates that the information processing device 100a has the management role.

[Step S112] The information processing device 100 transmits a license acquisition request to the information processing device 100a that has the management role.

[Step S113] The information processing device 100a receiving the license acquisition request decides whether or not the number of information processing devices by which the software is used at present is smaller than the simultaneous use information processing device number (licensed number) permitted by the license. If the number of information processing devices by which the software is used is smaller than the licensed number, then the processing is advanced to step S117. If the number of information processing devices by which the software is used reaches the licensed number, then the processing is advanced to step S114.

[Step S114] The information processing device 100a confirms the state of the information processing devices to which the license is given. For example, the information processing device 100a refers to the license use situation information 32 to recognize the information processing devices to which the license is given. Then, the information processing device 100a transmits a confirmation message regarding a software use state to the information processing devices to which the license is given. If any of the information processing devices that receive the confirmation message is using the software, then it returns a response that the software is being used. If the software is not being used in any information processing device receiving the confirmation message, then the information processing device returns a response that the software is not being executed. The information processing device 100a recognizes the use state of the software in the information processing devices to which the license is given on the basis of the responses from the information processing devices.

[Step S115] The information processing device 100a decides whether or not an information processing device by which the software is not being used at present exists among the information processing devices to which the license is given. For example, if a response that the software is not being executed is received from at least one information processing device, then the information processing device 100a decides that an information processing device by which the software is not being used exists. If an information processing device by which the software is not being used exists, then the processing is advanced to step S116. If an information processing device by which the software is not being used does not exist, then the processing is advanced to step S121.

[Step S116] The information processing device 100a transmits the stop information of the software in the information processing device by which the software is not being used to the other information processing devices in alternative. The information processing devices receiving the stop information reflect it on the license use situation information 32 that the use of the software by the pertaining information processing device has stopped.

[Step S117] The information processing device 100a updates the license use situation information 32. For example, the information processing device 100a adds, to the license use situation information 32, the node name of the information processing device 100 from which the license acquisition request has been transmitted as an information processing device by which the software is being used. Further, if an information processing device to which the license is given but by which the software is not being used exists, then the information processing device 100a deletes the node name of the information processing device from the license use situation information 32.

[Step S118] The information processing device 100a transmits an activation permission notification to the information processing device 100. As a result, processes at step S119 and step S120 are executed in parallel.

[Step S119] The information processing device 100a transmits the latest license use situation information 32 to the information processing device 100 and those information processing devices by which the software is being used at present.

[Step S120] The information processing device 100 receiving the activation permission notification activates the software. Consequently, activation of the software is completed normally.

On the other hand, if the licensed number is not reached, then the following process is performed.

[Step S121] The information processing device 100a notifies the information processing device 100 of an upper limit error of the licensed number.

[Step S122] The information processing device 100 displays the licensed number upper limit error on the monitor 21 and ends the activation process of the software as an error.

In this manner, upon activation of the software in any of the information processing devices in the LAN 60, license allocation within the licensed number is performed appropriately by the information processing device having the management role. Further, in response to increase of an information processing device by which the software is used, the license use situation information and the management role information processing device information are updated in the information processing devices by which the software is being executed.

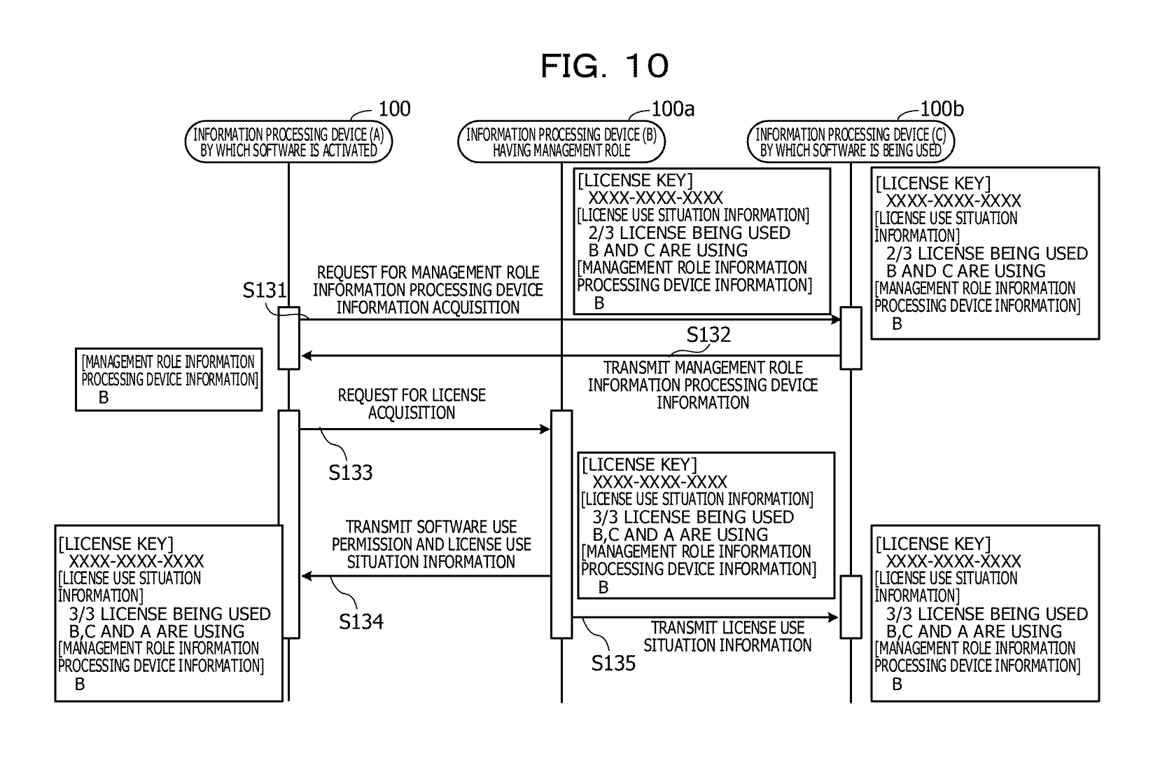

FIG. 10 is a sequence diagram illustrating an example of information updating in response to activation of software. The example of FIG. 10 assumes a case in which the information processing device 100a of the node name “B” has the management role and the information processing device 100 of the node name “A” activates the software while the information processing device 100b of the node name “C” is using the software. It is to be noted that also the information processing device 100a having the management role is using the software. In this case, as the license use situation information of the two information processing devices 100a and 100b by which the software is being used, it is registered that the information processing devices of the node names “B” and “C” are using the software. It is to be noted that, in the example of FIG. 10, presumably the licensed number is “3.” Therefore, in the license use situation information, it is indicated that the use situation of the license is “2/3 (simultaneous use information processing device number/licensed number).”

If activation of the software is started in the information processing device 100, then, for example, the information processing device 100 transmits an acquisition request for management role information processing device information to the information processing device 100b (step S131). In response to the acquisition request for management role information processing device information, the information processing device 100b transmits management role information processing device information retained thereby to the information processing device 100 (step S132). The management role information processing device information indicates that the information processing device 100a of the node name “B” has the management role. The information processing device 100 stores the received management role information processing device information into the memory 102.

The information processing device 100 recognizes from the acquired management role information processing device information that the information processing device 100a has the management role. Therefore, the information processing device 100 transmits a license acquisition request to the information processing device 100a having the management role (step S133). Even if the information processing device 100 is permitted to use the software, the simultaneous use information processing device number is equal to or smaller than the licensed number. Therefore, the information processing device 100a additionally writes the node name “A” of the information processing device 100 into a list of information processing devices by which the software is being used in the license use situation information and updates the in-use license number in the license use situation information to “3/3.”

Then, the information processing device 100a transmits a software use permission and the latest license use situation information to the information processing device 100 (step S134). The information processing device 100 stores the license use situation information received from the information processing device 100a into the memory 102 and starts use of the software. Further, the information processing device 100a transmits the latest license use situation information also to the information processing device 100b by which the software has been used (step S135). The information processing device 100b updates the license use situation information owned thereby in accordance with the received license use situation information.

The license use situation information in all of the information processing devices 100, 100a and 100b by which the software is being used is updated to the latest license use situation information in this manner.

If use of the software is ended in an information processing device to which the license is allocated, then the license allocated to the information processing device is released. Also in this case, the license use situation information is updated in all of the information processing devices by which the software is being used.

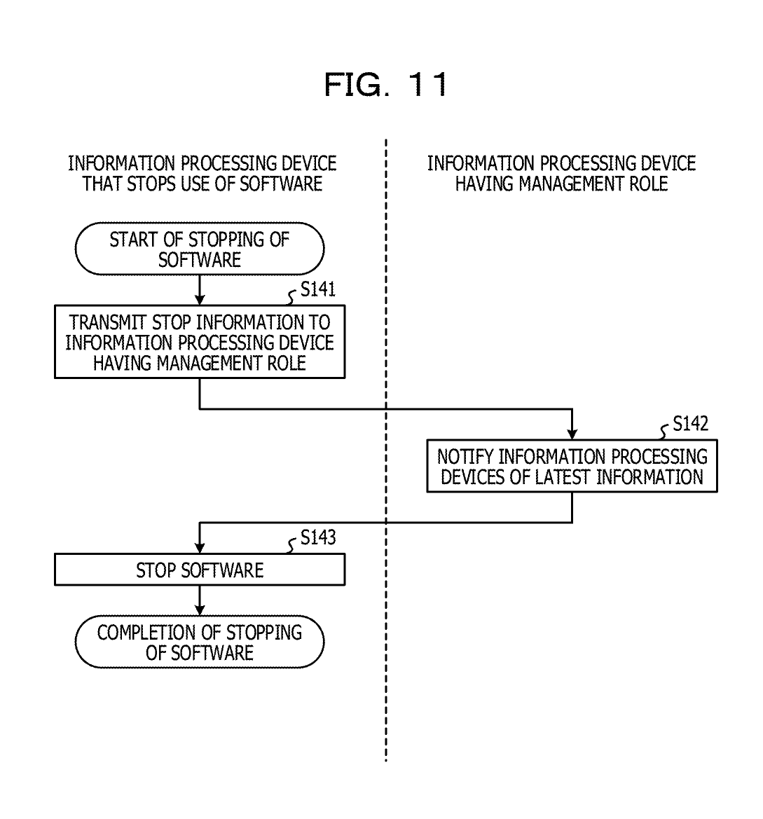

FIG. 11 is a flow chart illustrating an example of a procedure of a process upon stopping of software. In the following, the process of FIG. 11 is described assuming a case in which the information processing device 100 stops use of software when the information processing device 100a has the management role.

[Step S141] After the information processing device 100 starts a stopping process of software, it transmits stop information to the information processing device 100a that has the management role.

[Step S142] The information processing device 100a receiving the stop information deletes the node name “A” of the information processing device 100 from the list of information processing devices by which the software is being used in the license use situation information owned by the information processing device 100a. The information processing device 100a decrements the value of the simultaneous use information processing device number in the license use situation information by one. Then, the information processing device 100a notifies all of the information processing devices, by which software is being used, of the latest license use situation information. Each of the information processing devices receiving the latest license use situation information updates the license use situation information of itself.

[Step S143] After the license use situation information is updated, the information processing device 100 stops execution of the software.

In this manner, also when the software is stopped, the license use situation information is updated in all of the information processing devices by which the software is being used. Since the license use situation information in the information processing devices is updated synchronously, the management role can be transferred readily between the information processing devices. As a principal case in which the management role is transferred, a case is available in which the software is stopped in the information processing device that has the management role (first case). Also another case is available in which, in a state in which an information processing device that has the management role does not exist, some information processing device comes to have the management role (second case).

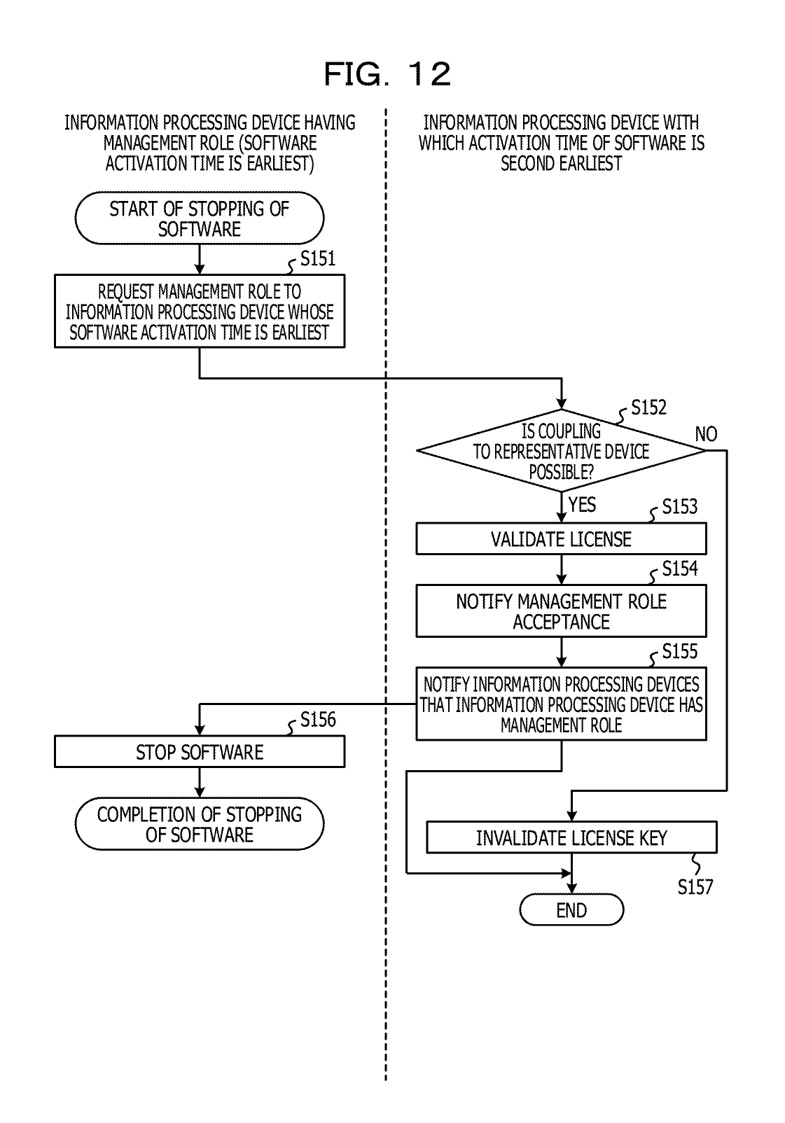

FIG. 12 is a flow chart illustrating an example of a procedure in regard to the first case of management role transfer. In the following, the process of FIG. 12 is described assuming a case in which the information processing device 100a has the management role and the management role is transferred to the information processing device 100b. It is to be noted that, in the example of FIG. 12, the management role is provided preferentially to an information processing device whose software activation time is earliest.

[Step S151] If the information processing device 100a starts a stopping process of software, then the information processing device 100a specifies the information processing device whose software activation time is earliest from among the information processing devices by which the software is being executed other than the information processing device 100a. In the example of FIG. 12, the information processing device 100b is specified. Then, the information processing device 100a requests the management role to the specified information processing device 100b.

[Step S152] The information processing device 100b receiving the request of the management role decides whether or not it is coupleable to a representative device. For example, the information processing device 100b decodes the license key to extract an IP address and a MAC address from the license key. Then, the information processing device 100b acquires, from a device corresponding to the extracted IP address, a MAC address of the device. If the acquired MAC address is identical with the MAC address extracted from the license key, then the information processing device 100b decides that it is coupleable to the representative device. If it is coupleable to the representative device, then the processing is advanced to step S153. However, if the information processing device 100b is not coupleable to the representative device, then the processing is advanced to step S157.

[Step S153] The information processing device 100b validates the license. For example, the information processing device 100b sets a flag indicating that the license is valid in association with the license key held thereby in the memory.

[Step S154] The information processing device 100b transmits an acceptance notification of the management role to the information processing device 100a. Thereafter, processes at step S155 and step S156 are executed in parallel.

[Step S155] The information processing device 100b transmits information indicating that the information processing device 100b has the management role to the information processing devices by which the software is being used.

[Step S156] The information processing device 100a receiving the acceptance notification of the management role stops execution of the software.

[Step S157] If the information processing device 100b fails to couple to the representative device, then it invalidates the license key. For example, the information processing device 100b sets a flag indicating that the license is invalid in association with the license key held thereby in the memory.

In this manner, when the software is stopped in the information processing device 100a that has the management role, the management role is transferred to the information processing device 100b that can establish coupling with the representative device. It is to be noted that, in the example of FIG. 12, if the information processing device 100b fails to couple to the representative device, then the information processing device that has the management role disappears from the system. In this case, when an information processing device that uses the software appears newly, the management role is requested to any information processing device.

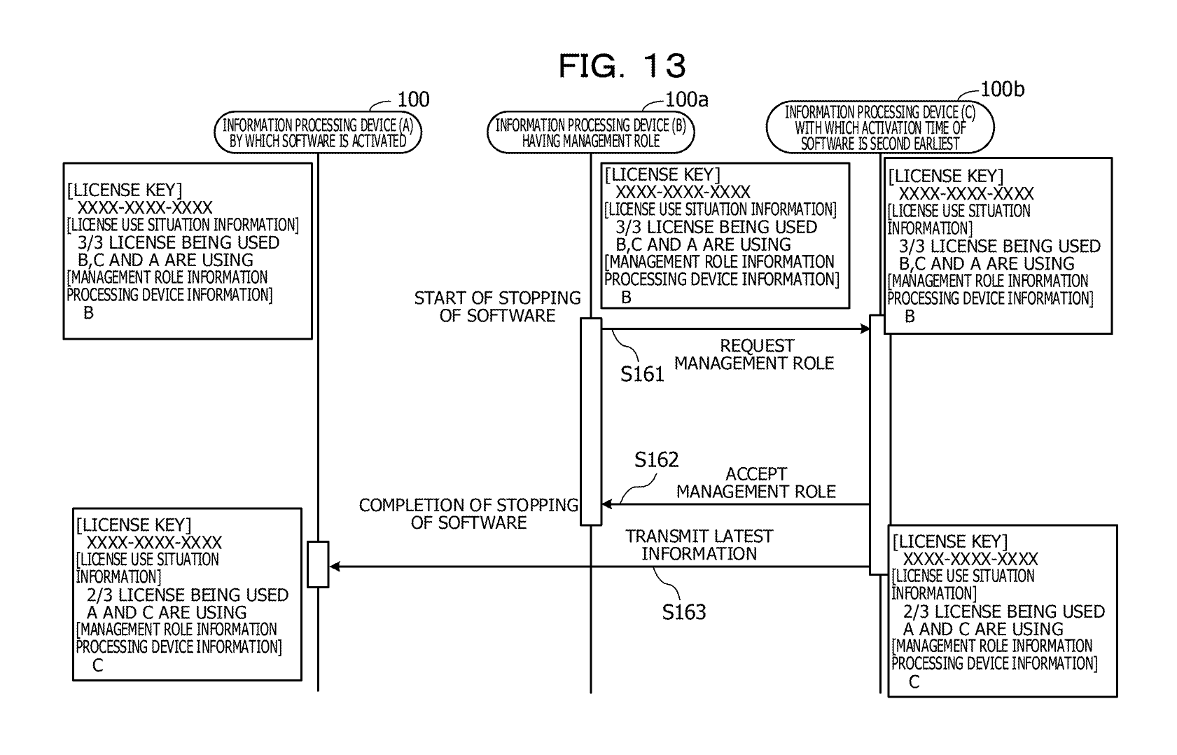

FIG. 13 is a view illustrating an example of information updating in response to stopping of software. The example of FIG. 13 assumes a case in which the information processing device 100a of the node name “B” has the management role and, while the software is being used by the information processing devices 100, 100a and 100b of the node names “A,” “B” and “C,” the use of the software is stopped by the information processing device 100a of the node name “B.” In this case, as the license use situation information of the three information processing devices 100, 100a and 100b by which the software is being used, it is registered that the software is being used by the information processing devices of the node names “A,” “B” and “C.” It is to be noted that, in the example of FIG. 13, presumably the licensed number is “3.” Therefore, the license use situation information indicates that the use situation of the license is “3/3.” Further, the activation time of the software by the three information processing devices 100, 100a and 100b is such that it is earliest with the information processing device 100a having the management role and is second earliest with the information processing device 100b.

If a stopping process of the software by the information processing device 100a having the management role is started in such a situation as just described, then a management role request is transmitted from the information processing device 100a to the information processing device 100b with which the activation time of the software is second earliest (step S161). The information processing device 100b accepts to hold the management role and transmits a response of management role acceptance to the information processing device 100a (step S162).

The information processing device 100a receiving the response of management role acceptance completes the stopping process of the software. The information processing device 100b that comes to have the management role newly updates the license use situation information in response to the stopping of the software in the information processing device 100a. In particular, the information processing device 100b deletes the node name “B” of the information processing device 100a from the list of information processing devices by which the software is being used and changes the in-use license number to “2/3.” Further, the information processing device 100b sets its own node name “C” as the management role information processing device information. Then, the information processing device 100b transmits the latest information of the license use situation information and the management role information processing device information to the information processing device 100 by which the software is being used (step S163). Consequently, the information of the information processing devices by which the software is being used is updated to the latest state.

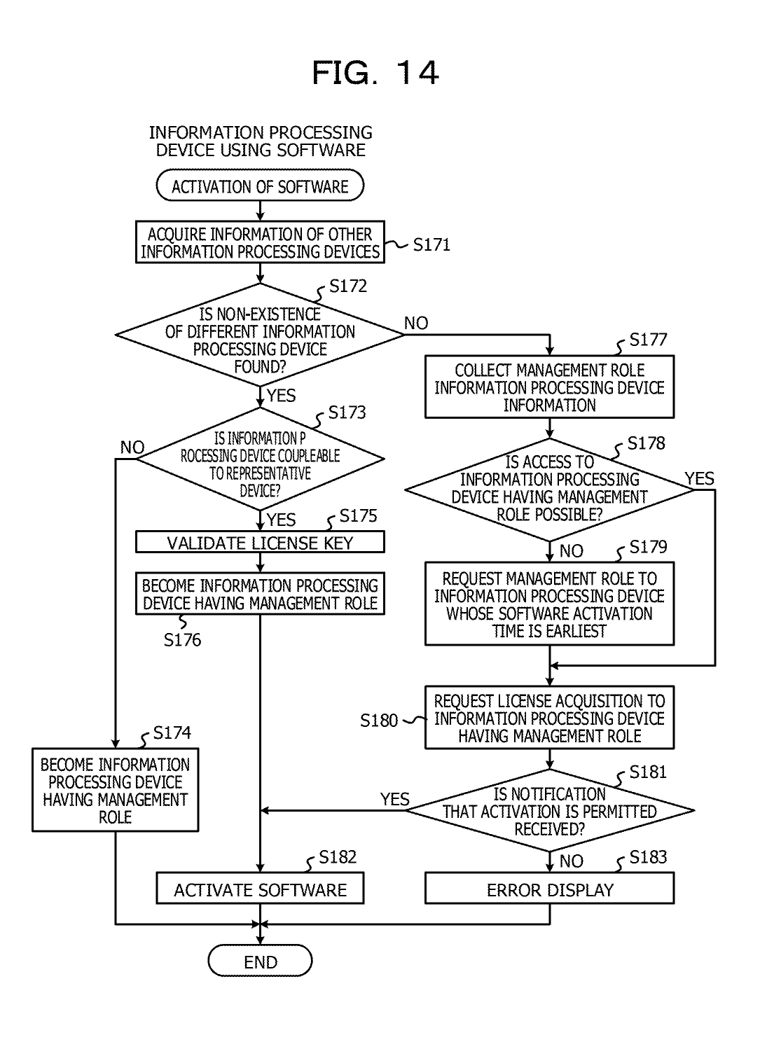

Now, a management role transfer process when an information processing device having the management role does not exist in the LAN is described with reference to FIG. 14. It is to be noted that the process depicted in FIG. 14 illustrates particulars of the process upon activation of software by an “information processing device that uses the software” depicted in FIG. 9.

FIG. 14 is a flow chart illustrating an example of a procedure regarding the second case of management role transfer. In the following, the process of FIG. 14 is described assuming a case in which the software is activated in the information processing device 100a.

[Step S171] If an activation request for the software is inputted, then the information processing device 100a acquires information of the other information processing devices by which the software is being used in the LAN coupled by P2P communication. For example, the information processing device 100a communicates with the information processing devices by which the software is being used by P2P coupling.

[Step S172] The information processing device 100a decides whether or not there exists a different information processing device by which the software is being used. If such a different information processing device exists, then the processing is advanced to step S177. However, if a different information processing device does not exist, then the processing is advanced to step S173.

[Step S173] The information processing device 100a decides whether or not it is coupleable to a representative device. If it is coupleable to a representative device, then the processing is advanced to step S175. However, if it is not coupleable to a representative device, then the processing is advanced to step S174.

[Step S174] The information processing device 100a invalidates the license key and ends the processing without activating the software.

[Step S175] The information processing device 100a validates the license key.

[Step S176] The information processing device 100a itself becomes an information processing device that has the management role. For example, the information processing device 100a sets its own node name to the management role information processing device information. Thereafter, the processing is advanced to step S182.

[Step S177] The information processing device 100a collects management role information processing device information from the other information processing devices by which the software is being used. The information processing device 100a recognizes the information processing device that has the management role at present on the basis of the collected management role information processing device information.

[Step S178] The information processing device 100a decides whether or not it is accessible to the information processing device having the management role. For example, the information processing device 100a transmits a given message to the information processing device having the management role and decides whether or not it is accessible depending upon whether or not a response to the message is received. If the information processing device 100a is accessible to the information processing device having the management role, then the processing is advanced to step S180. However, if the information processing device 100a is not accessible to the information processing device having the management role, then the processing is advanced to step S179.

[Step S179] The information processing device 100a requests the management role to an information processing device whose activation time of the software is earliest. If the information processing device 100a receives a response of acceptance of the management role from the information processing device to which the management role is requested, then the processing advances to step S180. It is to be noted that the information processing device that accepts the management role performs processing similar to that of the “information processing device with which the activation time of the software is second earliest” depicted in FIG. 12.

[Step 180] The information processing device 100a transmits a license acquisition request to the information processing device having the management role.

[Step S181] The information processing device 100a decides whether or not a notification that it is permitted to activate the software is received from the information processing device having the management role. If a notification that the information processing device 100a is permitted to activate the software is received, then the processing is advanced to step S182. However, if the information processing device 100a fails to receive a notification that it is permitted to activate the software, then the processing is advanced to step S183.

[Step S182] The information processing device 100a activates the software and ends the process.

[Step S183] The information processing device 100a performs error display and ends the process without activating the software.

In this manner, when an information processing device that has the management role does not exist, an information processing device whose activation time of the software is earliest holds the management role. For example, also in a case in which an information processing device having the management role fails to end the software correctly by some failure of the information processing device, a different information processing device executes the process depicted in FIG. 14 thereby to allow transfer of the management role.

As described above, in the second embodiment, one of a plurality of information processing devices has the management role and manages the floating license. Therefore, there is no necessity to separately prepare a license management server that does not execute software. Besides, the information processing device that has the management role can be changed dynamically to any of the information processing devices by which the software is being executed. Therefore, even if the software stops in the information processing device that has the management role, it is possible to transfer the management role to a different information processing device such that the license management process can be taken over to the different information processing device. As a result, even if a license management server is not used, license management having high reliability can be achieved.

Further, identification information of a representative device is included in the license key, and an information processing device that fails to establish coupling with the representative device is not permitted to have the management role. Consequently, a LAN other than the LAN of the license target is disabled to use the license key, and therefore, illegal use of the license is avoided.

Although the embodiments are exemplified, the configuration of the components indicated in the embodiments can be exchanged for different components having similar functions. Further, some other arbitrary component or step may be added. Furthermore, two or more arbitrary ones of the configurations (features) in the embodiments described above may be combined suitably.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A first information processing device among a plurality of information processing devices that configure a system, the first information processing device comprising:
a memory configured to store a license key of software to be executed simultaneously by a part of the plurality of information processing devices equal to or smaller than a licensed number in the system; and
a processor coupled to the memory and configured to:
decide, when activation of the software is commanded, whether or not a second information processing device that has management authority of a license of the software exists in the system;
when the second information processing device having the management authority exists,
transmit an inquiry about whether or not execution of the software is permissible to the second information processing device, and
receive a response including a determination result from the second information processing device; and
when the second information processing device having the management authority does not exist,
decide whether the license key is legal through communication with a particular device different from the plurality of information processing devices,
activate, when the license key is decided to be legal, the software and set the management authority to the first information processing device,
acquire execution information indicating a number of the part of the plurality of the information processing devices by which the software is being executed from among the plurality of information processing devices,
determine, when receiving a different inquiry about whether or not execution of the software is to be permitted from a third information processing device, whether or not the execution of the software is to be permitted on the basis of the execution information and the licensed number, and
transmit another response including another determination result to the third information processing device.

2. The first information processing device according to claim 1, wherein the license key includes identification information of the particular device.

3. The first information processing device according to claim 2, wherein
the license key is encrypted information, and
the processor decrypts the license key to acquire the identification information, accesses a coupling destination corresponding to the identification information to acquire identification information of the coupling destination and decides, when the identification information of the coupling destination and the identification information acquired from the license key coincide with each other, that the license key information is legal.

4. The first information processing device according to claim 1, wherein the processor is configured to:
notify, when the management authority is set to the first information processing device, the information processing devices other than the first information processing device from among the plurality of information processing devices that the first information processing device has the management authority.

5. The first information processing device according to claim 1, wherein the processor is configured to:
decide, when a notification that the second information processing device has the management authority is received from the second information processing device, that the second information processing device having the management authority exists.

6. The first information processing device according to claim 1, wherein the execution information is collected by peer to peer communication between the information processing devices by which the software is being executed.

7. A management method for managing a license of software capable of being executed individually by a plurality of information processing devices, the management method comprising:
changing, by a first information processing device included in the plurality of information processing devices, a mode of the first information processing device to a mode in which management of the license is to be performed;
collecting, by the first information processing device, execution information indicative of whether or not the software is being executed by each of the plurality of information processing devices;
inquiring, by a second information processing device included in the plurality of information processing devices other than the first information processing device, the first information processing device about whether or not execution of the software is to be permitted;
deciding, by the first information processing device in the mode in which management of the license is to be performed, in response to the inquiry from the second information processing device, whether or not the execution of the software by the second information processing device is to be permitted on the basis of license information indicative of a number of information processing devices that can execute the software simultaneously and the execution information; and
outputting a decision result to the second information processing device.

8. A non-transitory storage device storing a management program for managing a license of software capable of being executed individually by a plurality of information processing devices, the management program causing an information processing device to execute a process, the process comprising:
changing, by a first information processing device included in the plurality of information processing devices, a mode of the first information processing device to a mode in which management of the license is to be performed;
collecting, by the first information processing device, execution information indicative of whether or not the software is being executed by each of the plurality of information processing devices;
inquiring, by a second information processing device included in the plurality of information processing devices other than the first information processing device, the first information processing device about whether or not execution of the software is to be permitted;
deciding, by the first information processing device in the mode in which management of the license is to be performed, in response to the inquiry from the second information processing device, whether or not the execution of the software by the second information processing device is to be permitted on the basis of license information indicative of a number of information processing devices that can execute the software simultaneously and the execution information; and
outputting a decision result to the second information processing device.
